(19) United States
(12) Patent Application Publication
(10) Pub. No.: US 2024/0331165 A1
(43) Pub. Date: Oct. 3, 2024

(54) CROSS-DOMAIN REMOTE SENSING IMAGE SEMANTIC SEGMENTATION METHOD BASED ON ITERATIVE INTRA-DOMAIN ADAPTATION AND SELF-TRAINING

(71) Applicant: ZHEJIANG UNIVERSITY, HANGZHOU, Zhejiang Province (CN)

(72) Inventors: JIANWEI YIN, HANGZHOU, ZHEJIANG PROVINCE (CN); YUXIANG CAI, HANGZHOU, ZHEJIANG PROVINCE (CN); YINGCHUN YANG, HANGZHOU, ZHEJIANG PROVINCE (CN); YONGHENG SHANG, HANGZHOU, ZHEJIANG PROVINCE (CN); ZHENQIAN CHEN, HANGZHOU, ZHEJIANG PROVINCE (CN); ZHENGWEI SHEN, HANGZHOU, ZHEJIANG PROVINCE (CN)

(21) Appl. No.: 18/579,793

(22) PCT Filed: Apr. 28, 2022
(86) PCT No.: PCT/CN2022/090009

§ 371 Date: Jan. 16, 2024

(30) Foreign Application Priority Data
Apr. 18, 2022 (CN) 202210402338.4

(51) Int. Cl. G06T 7/12; G06T 7/11

(52) U.S. Cl. CPC G06T 7/12; G06T 7/11; G06T 2207/20081

(57) ABSTRACT

A cross-domain remote sensing image semantic segmentation method based on iterative intra-domain adaptation and self-training, includes training source-target inter-domain domain adaptation models, generating target domain category segmentation probabilities and pseudo labels, sorting target domain image segmentation probability credibility scores, training target intra-domain iterative domain adaptation models, and generating target domain segmentation results. The invention utilizes source-target domain inter-domain adaptation to reduce source-target domain inter-domain differences, and, utilizes target intra-domain adaptation to reduce target intra-domain differences and improve the accuracy of cross-domain remote sensing image semantic segmentation models; furthermore, by proposed classifying and sorting target domain images based on segmentation probability credibility, prediction results with good segmentation effects are selected as pseudo labels; meanwhile, a new pseudo label screening strategy is proposed to remove pixel points that are highly likely to be erroneous from pseudo labels, thereby avoiding the impact caused by erroneous pseudo labels during self-training within target domains.

### FIELD OF TECHNOLOGY

The present invention belongs to the technical field of semantic segmentation of remote sensing images, and in particular relates to a cross-domain remote sensing image semantic segmentation method based on iterative intra-domain adaptation and self-training.

### BACKGROUND TECHNOLOGY

With the continuous development of remote sensing technology, remote sensing devices such as satellites and drones can collect a large number of remote sensing satellite images. For example, the drones can capture a large number of high-spatial-resolution remote sensing images over cities and rural areas. Such massive remote sensing data provides many application opportunities, such as urban monitoring, urban management, agriculture, automatic mapping, and navigation. Among these applications, the key technology is semantic segmentation or image classification of remote sensing images.

In recent years, convolutional neural network (CNN) has become the most commonly used technique in semantic segmentation and image classification, and some CNN-based models have demonstrated their effectiveness in this task, such as FCN, SegNet, U-Net series, PSPNets, and DeepLab series. When training images and test images come from the same satellite or city, these models can all achieve good semantic segmentation results. However, when we use these models for classification of remote sensing images obtained from different satellites or cities, due to the different data distribution between different satellite and city images (domain shift), the test results of the models will become very poor and unsatisfactory. In some relevant literature, this problem is referred to as domain adaptation; in the field of remote sensing, domain shift is usually caused by different atmospheric conditions, acquisition differences (these differences will change the spectral characteristics of objects), differences in the spectral characteristics of sensors, or/and different types of spectral bands (such as some images may be in the red, green, and blue bands, while others may be in the near-infrared, red, and green bands) during imaging of remote sensing devices.

In a typical domain adaptation problem, training images and test images are usually designated as source domain and target domain. A common solution for processing domain adaptation is to create a new semantic labeled dataset on a target domain and train a model thereon. Due to the fact that collecting a large number of pixel labeled images of a target city is time-consuming and expensive, and this solution is very expensive and impractical, in order to reduce the workload of manual pixel classification, there are already some solutions, such as synthesizing data from weakly supervised labels. However, these methods still have limitations as they also require a significant amount of manual labor.

In order to improve the generalization ability of CNN-based semantic segmentation models, another commonly used method is to randomly change colors for data augmentation, such as gamma correction and image brightness conversion, which have been widely used in remote sensing. However, when there are significant differences in data distribution, the above data augmentation methods cannot achieve good results in cross-domain semantic segmentation. It is impossible to apply a model of a domain containing red, green, and blue bands to another domain containing near-infrared, red, and green channels using these simple augmentation methods. To overcome this limitation, generative adversarial network (GAN) [I. Goodfellow, J. Pouget-Abadie, M. Mirza, B. Xu, D. Warde-Farley, S. Ozair, A. Courville, and Y. Bengio. Generative adversarial nets[C]. Proceedings of the international conference on Neural Information Processing Systems (NIPS). 2014:2672-2680] is used for generating pseudo target domain images with similar data distributions to target domain images, and these generated pseudo target domain images can be used for training classifiers in the target domain. At the same time, some methods based on adversarial learning [Y.-H. Tsai, W.-C. Hung, S. Schulter, K. Sohn, M.-H. Yang, and M. Chandraker. Learning to adapt structured output space for semantic segmentation[C].” Proceedings of the international conference on computer vision and pattern recognition (CVPR). 2018:7472-7481] and self-training [Y. Zou, Z. Yu, B. Kumar, and J. Wang. Unsupervised domain adaptation for semantic segmentation via class-balanced self-training [C]. Proceedings of the international conference on European conference on computer vision (ECCV). 2018:289-305] have also been proposed by researchers to solve domain adaptation problems. Although these methods have achieved good effects in natural images, there are still certain problems in directly applying these methods to remote sensing images. The most important point is that these methods ignore the differences in the target domain images themselves, such as significant differences in building styles, shapes and the like within the same city.

Due to the differences in the target domain images themselves, the segmentation effect of inter-domain semantic segmentation models that migrate from the source domain to the target domain will also vary across all target domain images, that is, relatively accurate segmentation results can be obtained on some target domain images, but the segmentation results obtained on other target domain images will become very poor. Therefore, how to perform further intra-domain adaptation on target domain images and reduce the differences within the target domain, so that the cross-domain semantic segmentation model can achieve good segmentation effects on all target domain images, is an important issue faced by cross-domain remote sensing image semantic segmentation. Secondly, because the target domain images do not have corresponding labels, the commonly used method is to use self-training techniques to use semantic segmentation results generated by trained cross-domain semantic segmentation model as pseudo labels for the target domain images, and then use the pseudo labels to continue to train the cross-domain semantic segmentation models to obtain a final target domain semantic segmentation model. The training effect of this self-training model based on pseudo labels depends on the quality of the pseudo labels. When the quality of the pseudo labels is poor, the training effect of the model will also be greatly weakened, and the semantic segmentation ability of the model will also be greatly weakened. Therefore, how to select image results with good model segmentation effects as pseudo labels and how to improve the quality of pseudo labels are also important issues in self-training techniques.

### SUMMARY OF THE INVENTION

In view of the above, the present invention provides a cross-domain remote sensing image semantic segmentation method based on iterative intra-domain adaptation and self-training, which can migrate a semantic segmentation model trained on a remote sensing image in one domain to remote sensing images of another domains, and perform further intra-domain adaptation within a target domain remote sensing image, reducing target intra-domain shift while reducing inter-domain shift between source domain and target domain, thereby further improving the performance and robustness of cross-domain remote sensing image semantic segmentation models.

A cross-domain remote sensing image semantic segmentation method based on iterative intra-domain adaptation and self-training, including the following steps:
(1) using a source domain image xₛ, a source domain label yₛ, a source domain

semantic segmentation model F_{S}, and a target domain image xₜ to train a source-target inter-domain semantic segmentation model Fᵢₙₜₑᵣ;
(2) inputting the target domain image xₜ into the source-target inter-domain semantic segmentation model Fᵢₙₜₑᵣ to obtain a category segmentation probability Pₜ of the target domain image xₜ, and then using the category segmentation probability Pₜ to calculate segmentation probability credibility Sₜ and a target domain pseudo label [symbol] ;
(3) arranging all target domain images xₜ in descending order according to the segmentation probability credibility Sₜ, and then dividing all the target domain images xₜ into K subsets of target domain images {Xₜ¹, Xₜ², . . . , Xₜ^{K}} on average according to an order of arrangement, wherein K is a natural number greater than 1;
(4) using a subset of target domain images Xₜ¹ with highest segmentation probability credibility and a corresponding subset of pseudo labels [symbol] thereof, as well as the source-target inter-domain semantic segmentation model Fᵢₙₜₑᵣ and subsets of target domain images {Xₜ², Xₜ³, . . . , Xₜ^{K}} to iteratively train a target intra-domain semantic segmentation model Fᵢₙₜᵣₐ; and
(5) inputting the target domain image xₜ into the target intra-domain semantic segmentation model Fᵢₙₜᵣₐ to obtain a final category segmentation probability P and a segmentation result map of the target domain image xₜ.

Further, a specific implementation process of step (1) includes:
1.1 using the source domain image xₛ and the source domain label yₛ to train the source domain semantic segmentation model F_{S};
1.2 using the source domain image xₛ and the target domain image xₜ to train a

source-target domain image bidirectional translation network, comprising a source→target direction image translation network and a target→source direction image translation network;
1.3 for intermediate save models of all image translation networks generated during the training process described above, selecting therefrom a set of optimal results as a source→target direction image translation network G_{S→T} and a target→source direction image translation network G_{T→S};
1.4 using the image translation network G_{S→T} to convert the source domain image xₛ from a source domain to a target domain to obtain a pseudo target domain image G_{S→T}(xₛ) and
1.5 using the pseudo target domain image G_{S→T}(xₛ) and the source domain label yₛ to train the source-target inter-domain semantic segmentation model Fᵢₙₜₑᵣ.

Further, a calculation expression for the segmentation probability credibility Sₜ in step (2) is as follows:

$${S}_{t} = \frac{H \times W \times C}{{\sum }_{h , w} θ ( {P}_{t}^{( h , w , {c}_{1} )} , {P}_{t}^{( h , w , {c}_{2} )} , … , {P}_{t}^{( h , w , {c}_{C} )} )}$$

wherein H and W are a length and a width of the target domain image xₜ, respectively, C is a number of segmentation categories in the target domain image xₜ, Pₜ^{(h,w,c}^{ᵢ}⁾ represents a segmentation probability of a corresponding category cᵢ of a pixel point with coordinates (h, w) in the target domain image xₜ, Cᵢ represents an i-th category, i is a natural number and satisfies 1≤i≤C, and θ( ) is a function used for measuring likelihood between segmentation probabilities of categories of pixel points.

Further, a calculation expression for the target domain pseudo label [symbol] in step (2) is as follows:

$${\hat{{y}_{t}}}^{( h , w )} = \{ \begin{matrix}c , if {P}_{t}^{( h , w , c )} > {μ}^{c} or {I}_{t}^{( h , w )} < ν \\ 0 , otherwise\end{matrix}$$

wherein [symbol] ^{(h,w)} represents a category of a pixel point with coordinates (h, w) in the target domain pseudo label [symbol] , Pₜ ^{(h,w,c)} represents a segmentation probability of a corresponding category c of the pixel point with coordinates (h, w) in the target domain image xₜ, μ^{c} is a segmentation probability threshold corresponding to the category c,

$$c = arg {max}_{{c}_{i}} {P}_{t}^{( h , w , {c}_{i} )} ,$$

Pₜ^{(h,w,c}^{ᵢ}⁾ represents a segmentation probability of a corresponding category cᵢ of the pixel point with coordinates (h, w) in the target domain image xₜ, Cᵢ represents an i-th category, i is a natural number and satisfies 1≤i≤C, C is a number of segmentation categories in the target domain image xₜ, Iₜ^{(h,w)} represents a segmentation probability perplexity of the pixel point with coordinates (h, w) in the target domain image xₜ, and v represents a segmentation probability perplexity threshold.

Further, a calculation expression for the segmentation probability perplexity Iₜ^{(h,w)} is as follows:

$${I}_{t}^{( h , w )} = δ ( {P}_{t}^{( h , w , {c}_{1} )} , {P}_{t}^{( h , w , {c}_{2} )} , … , {P}_{t}^{( h , w , {c}_{C} )} )$$

wherein δ( ) is a function used for measuring a perplexity between segmentation probabilities of categories of pixel points.

Further, a specific implementation process of step (4) includes:
4.1 initially using the subset of target domain images Xₜ¹ with highest segmentation probability credibility and the corresponding subset of pseudo labels [symbol] thereof as a training set Xₜ^{clean} and a corresponding label set [symbol] thereof, and using the source-target inter-domain semantic segmentation model Fᵢₙₜₑᵣ as a target intra-domain semantic segmentation model Fᵢₙₜᵣₐ¹;
4.2 using the training set Xₜ^{clean}, the label set [symbol] , a target intra-domain semantic segmentation model Fᵢₙₜᵣₐ^{k-1} and a subset of target domain images Xₜ^{k} to train a target intra-domain semantic segmentation model Fᵢₙₜᵣₐ^{k}, wherein k is a natural number and satisfies 2≤k≤K; the training process is similar to step (1);
4.3 inputting the subset of target domain images Xₜ^{k} into the target intra-domain semantic segmentation model Fᵢₙₜᵣₐ^{k} to obtain a corresponding category segmentation probability Pₜ^{k}, and then using the category segmentation probability Pₜ^{k} to calculate a subset of pseudo labels [symbol] of the subset of target domain images Xₜ^{k};
4.4 adding the subset of target domain images Xₜ^{k} and the subset of pseudo labels [symbol] thereof to the training set Xₜ^{clean} and the label set [symbol] , respectively;
4.5 letting k=k+1; and
4.6 repeating steps 4.2 to 4.5 until k=K, and training to obtain a target intra-domain semantic segmentation model Fᵢₙₜᵣₐ^{K}, which is used as the target intra-domain semantic segmentation model Fᵢₙₜᵣₐ.

The method of the present invention is a complete cross-domain remote sensing image semantic segmentation framework, including training of source-target inter-domain domain adaptation models, generation of target domain category segmentation probabilities and pseudo labels, sorting of target domain image segmentation probability credibility scores, training of target intra-domain iterative domain adaptation models, and generation of target domain segmentation results.

The present invention proposes an iterative domain adaptation training network within a target domain. When training the iterative domain adaptation training network, the present invention uses commonly used self-training learning techniques to guide the training of target domain segmentation models by means of using the part of images with good segmentation effects and segmentation results thereof as pseudo labels, so that target domain models can also achieve good segmentation results on the part of images with poor segmentation effects.

In addition, in order to address the characteristics of complex and diverse distribution within the target domain, the present invention also proposes to divide a target domain into a plurality of sub-domains and perform iterative intra-domain adaptation training on the plurality of sub-domains; in order to divide the target domain into the plurality of sub-domains, the present invention proposes a segmentation probability credibility calculation method, which sorts and classifies target domain images according to the scores of segmentation results of target domain models, and selects the part of the target domain images with good segmentation effects and pseudo labels thereof to further optimize the target domain model.

In the process of obtaining pseudo labels, the present invention proposes a method that combines a segmentation probability threshold and a segmentation probability perplexity threshold to remove pixel points with poor segmentation results from the pseudo labels, thereby avoiding low-quality pseudo labels interfering with target domain model training.

Based on the iterative domain adaptation training framework, the present invention achieves domain adaptation training within target domains. After obtaining a migration model from a source domain to a target domain and target domain segmentation results, the iterative domain adaptation training framework adopted by the present invention perform further intra-domain adaptation training on a target domain model, to obtain a final target domain model and semantic segmentation results, thereby improving the accuracy of cross-domain remote sensing image semantic segmentation.

### BRIEF DESCRIPTION OF THE DRAWINGS

FIG. 1[1] is a schematic diagram of steps of a cross-domain remote sensing image semantic segmentation method of the present invention.

FIG. 2 is a schematic diagram of a specific implementation process of the cross-domain remote sensing image semantic segmentation method of the present invention.

### DETAILED DESCRIPTION OF THE EMBODIMENTS

In order to provide a more specific description of the present invention, the following will provide a detailed explanation of the technical solution of the present invention in conjunction with accompanying drawings and specific implementations.

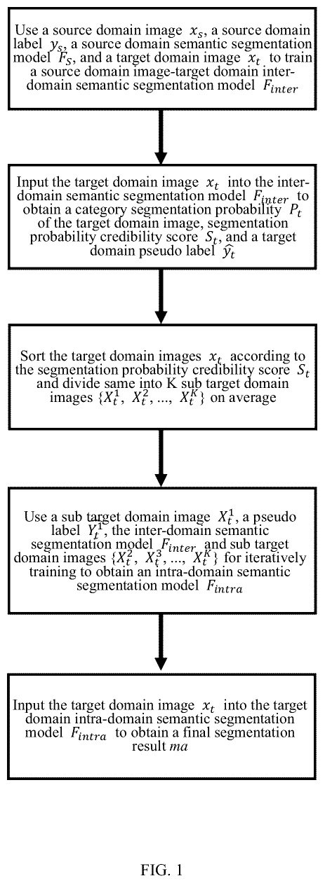

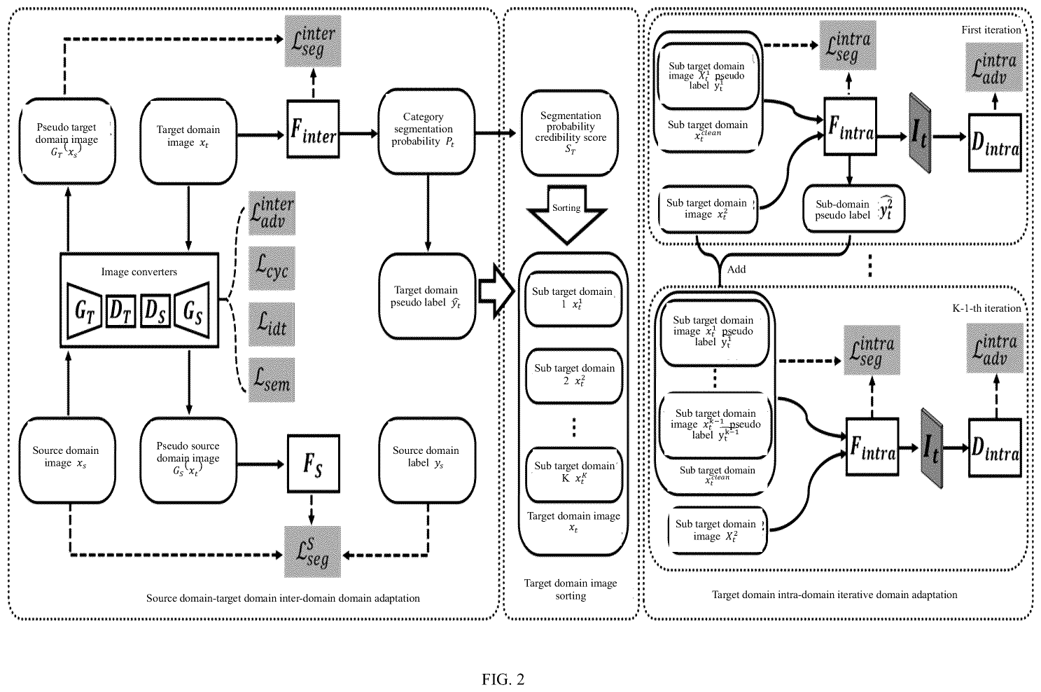

As shown in FIG. 1 and FIG. 2, a cross-domain remote sensing image semantic segmentation method based on iterative intra-domain adaptation and self-training of the present invention, includes the following steps:

(1) using a source domain image xₛ, a source domain label yₛ, a source domain semantic segmentation model Fₛ, and a target domain image xₜ to train a source-target inter-domain semantic segmentation model Fᵢₙₜₑᵣ.

In this implementation, when there is no source domain semantic segmentation model Fₛ, it can be obtained by training using the source domain image xₛ and the source domain label yₛ. Commonly used deeplab, U-net, etc. can be used as a model network structure. A loss function uses cross-entropy loss with K categories, and a corresponding formula is as follows:

$${ℒ}_{s e g}^{s} ( {F}_{S} , {x}_{s} , {y}_{s} ) = - 𝔼 {\sum }_{k = 1}^{K} {𝕀}_{[ k = {y}_{s} ]} log ( softmax ( {F}_{S}^{( k )} ( {x}_{s} ) ) )$$

wherein xₛ is a source domain image, yₛ is a source domain image label, K is a number of label categories, F_{S} is a semantic segmentation model on a source domain, Z,±_{[k=y}_{ₛ}_{]} is an indicator function (when k=yₛ, [symbol] _{[k=y}_{ₛ}_{]}=1; when k≠yₛ, [symbol] _{[k=y}_{ₛ}_{]}=0, reference for indicator function—ZHOU Zhihua. Machine Learning [M]. Beijing: Tsinghua University Press, 2016. Main symbol table), [symbol] represents a mathematical expectation function, and F_{S}^{(k)}(xₛ) is a k-th class result of output results obtained by inputting xₛ to a model Fₛ.

In this implementation, a Potsdam city image with building labels is taken as a source domain, and cropped into a size of 512*512 pixels, RGB 3 channels are retained, the number of images and the number of corresponding building labels are each 4000, deeplab V3+ can be used as a model network structure, a learning rate is 10⁻⁴, an optimization algorithm is adam, and a semantic segmentation model F_{S} on a Potsdam domain is obtained by training 900 epochs.

Commonly used inter-domain domain adaptation training from a source domain to a target domain is based on image conversion and adversarial learning. This embodiment illustrates a GAN-based image conversion method, but is not limited to an image conversion-based method. The image conversion-based method first requires training a bidirectional image conversion model between a source domain and a target domain. The bidirectional image conversion model includes an image translation network G_{S→T} from a source domain image xₛ to a target domain image xₜ, an image translation network G_{T→S} from the target domain image xₜ to the source domain image xₛ, as well as a source domain discriminator D_{S} and a target domain discriminator D_{T}. Training loss functions include a cycle consistency loss function, a semantic consistency loss function, a self-loss function, and an adversarial loss function.

An equation expression for the cycle consistency loss function is as follows:

$${ℒ}_{c y c} ( {G}_{S \to T} , {G}_{T \to S} , {x}_{s} , {x}_{t} ) = 𝔼 [ {‖ {G}_{T \to S} ( {G}_{S \to T} ( {x}_{s} ) ) - {x}_{s} ‖}_{1} ] + 𝔼 [ {‖ {G}_{S \to T} ( {G}_{T \to S} ( {x}_{t} ) ) - {x}_{t} ‖}_{1} ]$$

wherein xₛ is a source domain image, xₜ is a target domain image, G_{S→T} is an image translation network from the source domain image xₛ to the target domain image xₜ, G_{T→S} is an image translation network from the target domain image xₜ to the source domain image xₛ, [symbol] is a mathematical expectation function, and μ μ₁ is an L1 norm.

An equation expression for the semantic consistency loss function is as follows:

$${ℒ}_{s e m} ( {G}_{S \to T} , {G}_{T \to S} , {F}_{S} , {F}_{T} , {x}_{s} , {x}_{t} ) = 𝔼 \{ K L ( {F}_{S} ( {x}_{s} ) ‖ {F}_{T} ( {G}_{S \to T} ( {x}_{s} ) ) ) \} + 𝔼 \{ K L ( {F}_{T} ( {x}_{t} ) ‖ {F}_{S} ( {G}_{T \to S} ( {x}_{t} ) ) ) \}$$

wherein xₛ is a source domain image, xₜ is a target domain image, G_{S→T} is an image translation network from the source domain image xₛ to the target domain image xₜ, G_{T→S} is an image translation network from the target domain image xₜ to the source domain image xₛ, [symbol] is a mathematical expectation function, F_{T} is a semantic segmentation model on a target domain, F_{S} is a semantic segmentation model on a source domain, and KL(μ) is a KL divergence between two distributions.

An equation expression for the adversarial loss function is as follows:

$${ℒ}_{adv}^{inter} ( {G}_{S \to T} , {G}_{T \to S} , {D}_{S} , {D}_{T} , {x}_{s} , {x}_{t} ) = 𝔼 [ log {D}_{T} ( {x}_{t} ) ] + 𝔼 [ log ( 1 - {D}_{T} ( {G}_{S \to T} ( {x}_{s} ) ) ) ] + 𝔼 [ log {D}_{S} ( {x}_{s} ) ] + 𝔼 [ log ( 1 - {D}_{s} ( {G}_{T \to S} ( {x}_{t} ) ) ) ]$$

wherein xₛ is a source domain image, xₜ is a target domain image, G_{S→T} is an image translation network from the source domain image xₛ to the target domain image xₜ, G_{T→S} is an image translation network from the target domain image xₜ to the source domain image xₛ, [symbol] is a mathematical expectation function, D_{S} is a source domain discriminator, and D_{T} is a target domain discriminator. An equation expression for the self-loss function is as follows:

$${ℒ}_{idt} ( {G}_{S \to T} , {G}_{T \to S} , {x}_{s} , {x}_{t} ) = 𝔼 [ {‖ {G}_{T \to S} ( {x}_{s} ) - {x}_{s} ‖}_{1} ] + 𝔼 [ {‖ {G}_{S \to T} ( {x}_{t} ) - {x}_{t} ‖}_{1} ]$$

wherein xₛ is a source domain image, xₜ is a target domain image, G_{S→T} is an image translation network from the source domain image xₛ to the target domain image xₜ, G_{T→S} is an image translation network from the target domain image xₜ to the source domain image xₛ, [symbol] is a mathematical expectation function, and ∥·∥₁ is an L1 norm.

In this implementation, a Potsdam city image is taken as a source domain, and a Vaihingen city image is taken as a target domain, with an image size of 512*512 pixels and with 3 channels. The number of Potsdam city images (source domain) is 832, and the number of Vaihingen city images (target domain) is 845, the images including buildings. The image conversion model uses GAN, which includes an image translation network G_{S→T} from a Potsdam image xₛ to a Vaihingen image xₜ, an image translation network G_{T→S} from the Vaihingen image xₜ to the Potsdam image xₛ, as well as a Potsdam domain discriminator D_{S}and a Vaihingen domain discriminator D_{T}. A generator network structure is 9 layers of ResNet. A discriminator network structure is of 4 layers of CNNs. Training loss functions include a cycle consistency loss function, a semantic consistency loss function, an adversarial loss function, and a self-loss function. A learning rate is 10⁻⁴. An optimization algorithm is adam. After training 100 epochs, the training is stopped. After the training is completed, a Potsdam-Vaihingen direction image translation network G_{S→T} and 10 Vaihingen-Potsdam direction image translation networks G_{T→S} are obtained. Then, 4000 Potsdam satellite images with 512*512pixels and 3channels are converted from the Potsdam domain to the Vaihingen domain using a translation network G_{S→T}, to obtain a pseudo Vaihingen image G_{S→T}(Xₛ). The pseudo Vaihingen (target domain) image G_{S→T}(xₛ) and the Potsdam (source domain) label yₛ are then used to train a pseudo Vaihingen (target domain) semantic segmentation model Fᵢₙₜₑᵣ.

Commonly used deeplab, U-net, etc. can be used as a model network structure. A loss function uses cross-entropy loss with K categories, and a corresponding formula is as follows:

$${ℒ}_{s e g}^{inter} ( {F}_{inter} , {G}_{S \to T} ( {x}_{s} ) , {y}_{s} ) = - 𝔼 {\sum }_{k = 1}^{K} {𝕀}_{[ k = {y}_{s} ]} log ( softmax ( {F}_{inter}^{( k )} ( {G}_{S \to T} ( {x}_{s} ) ) ) )$$

wherein xₛ is a source domain image, yₛ is a source domain image label, K is a number of label categories, Fᵢₙₜₑᵣ is a semantic segmentation model on a source domain, [symbol] _{[k=y}_{ₛ}_{]} is an indicator function (when k=yₛ, [symbol] _{[k=y}_{ₛ}_{]}=1; when k≠yₛ, [symbol] _{[k=y}_{ₛ}_{]}=0), [symbol] represents a mathematical expectation function, G_{S→T}(xₛ) is a pseudo target domain image, and Fᵢₙₜₑᵣ^{(k)}(G_{S→T}(xₛ)) is a k-th class result of output results obtained by inputting G_{S→T}(xₛ) to a model Fᵢₙₜₑᵣ.

In this implementation, 4000 pseudo Vaihingen domain images G_{S→T}(xₛ) with 512*512 pixels and 3 channels and the source domain label yₛ generated in step (1) are used to train a semantic segmentation model Fᵢₙₜₑᵣ on the Vaihingen domain; deeplab V3+ is used as a model network structure, a learning rate is 10⁻⁴, an optimization algorithm is adam, and a semantic segmentation model Fᵢₙₜₑᵣ on a pseudo Vaihingen domain is obtained by training 100 epochs.

(2) Inputting the target domain image xₜ into the source-target inter-domain semantic segmentation model Fᵢₙₜₑᵣ to obtain a category segmentation probability Pₜ of the target domain image xₜ, and then using the category segmentation probability Pₜ to calculate segmentation probability credibility S_{T} and a target domain pseudo label [symbol] .

In this implementation, 500 Vaihingen domain image xₜ, with 512*512 pixels and 3 channels are input into the source-target inter-domain semantic segmentation model Fᵢₙₜₑᵣto obtain the category segmentation probability Pₜ of the target domain image xₜ, and the category segmentation probability Pₜ is used to calculate the segmentation probability credibility S_{T} and the target domain pseudo label [symbol] . A calculation method for calculating the segmentation probability credibility Sₜ is as follows:

$${S}_{t} = \frac{H \times W \times C}{{\sum }_{h , w} {\prod }_{c} {P}_{t}^{( h , w , c )}}$$

wherein Σ represents a mathematical summation symbol, [symbol] represents a mathematical product symbol, H is a length of a target domain image xₜ, W is a width of the target domain image xₜ, C is a number of classification categories of the target domain image Xₜ, Pₜ is a category segmentation probability (a matrix with a size of H×W×C) obtained by inputting the target domain image xₜ into the semantic segmentation model Fᵢₙₜₑᵣ, Pₜ^{(h,w,c)} is a category segmentation probability of a pixel point with coordinates (h, w) and category c in the category segmentation probability Pₜ, and

[symbol] _{c}Pₜ^{(h,w,c)} is to calculate a product of category segmentation probabilities corresponding to each category c of pixel points with coordinates (h, w).

A method for obtaining the target domain pseudo label [symbol] using the category segmentation probability Pₜ is as follows:

$$\hat{{y}_{t}} = \{ \begin{matrix}c , if {P}_{t}^{( h , w , c )} > {μ}^{c} or {I}_{t}^{( h , w )} < v and arg {max}_{\tilde{c}} {P}_{t}^{( h , w , \tilde{c} )} = c \\ 0 , otherwise\end{matrix}$$

wherein argmax is a function that takes a maximum value, argmax_{\tilde{c}}Pₜ^{(h,w,c)} is a category \tilde{c} with highest category segmentation probability among pixel points with coordinates (h, w) in the category segmentation probability Pₜ, μ^{c} is a segmentation probability threshold used for generating pseudo labels for the category c, Iₜ^{(h,w)} is segmentation probability perplexity of the pixel point with coordinates (h, w) in the target domain image xₜ, and v is a segmentation probability perplexity threshold used for generating pseudo labels. A calculation method for the segmentation probability perplexity Iₜ^{(h,w)} is as follows:

$${I}_{t}^{( h , w )} = {\prod }_{c} {P}_{t}^{( h , w , c )}$$

wherein [symbol] represents a mathematical product symbol, H is a length of a target domain image xₜ, W is a width of the target domain image xₜ, C is a number of classification categories of the target domain image xₜ, and [symbol] _{c}Pₜ^{(h,w,c)} is to calculate a product of category segmentation probabilities corresponding to each category c of the pixel point with coordinates (h, w).

(3) Sorting the segmentation probability credibility Sₜ of the 500 Vaihingen (target) domain images xₜ in descending order according to numerical values, and then dividing the target domain images xₜ into 4 subsets of target domain images {Xₜ¹, Xₜ², Xₜ³, Xₜ⁴} on average according to the sorted segmentation probability credibility Sₜ.

(4) Using a subset of Vaihingen (target) domain images Xₜ¹ with highest segmentation probability credibility and a corresponding subset of pseudo labels [symbol] thereof, the source-target inter-domain semantic segmentation model Fᵢₙₜₑᵣ and subsets of target domain images {Xₜ², Xₜ³, Xₜ⁴} for iteratively training to obtain a target intra-domain semantic segmentation model Fᵢₙₜᵣₐ.

The intra-domain single-domain adaptation method adopted in this implementation is explained using an adversarial learning-based methods, but not limited to same. The adversarial learning-based method requires an intra-domain semantic segmentation model Fᵢₙₜᵣₐ and a discriminator Dᵢₙₜᵣₐ. Training loss functions include a semantic segmentation loss function and an adversarial loss function.

An equation expression for the semantic segmentation loss function is as follows:

$${ℒ}_{s e g}^{intra} ( {F}_{intra} , {X}_{i} , {Y}_{i} ) = - 𝔼 {\sum }_{k = 1}^{K} {𝕀}_{[ k = {Y}_{i} ]} log ( softmax ( {F}_{intra}^{( k )} ( {X}_{i} ) ) )$$

wherein Xᵢ is a subset of target domain images of an i-th part, yᵢ is a subset of pseudo labels corresponding to xᵢ, K is a number of label categories, Fᵢₙₜᵣₐ is a semantic segmentation model on a target domain, [symbol] _{[k=y}_{ᵢ}_{]} is an indicator function (when k=Yᵢ, [symbol] _{[k=Y}_{ᵢ}_{]}=1; when k≠Yᵢ, [symbol] _{[k=Y}_{ᵢ}^{]}=0, reference for indicator function—ZHOU Zhihua. Machine Learning [M]. Beijing: Tsinghua University Press, 2016. Main symbol table), [symbol] represents a mathematical expectation function, and Fᵢₙₜᵣₐ^{(k)}(Xᵢ) is a k-th class result of output results obtained by inputting Xᵢ to a model Fᵢₙₜᵣₐ.

An equation expression for the adversarial loss function is as follows:

$${ℒ}_{s e g}^{intra} ( {X}_{i} ) = - 𝔼 [ log {D}_{intra} ( {X}_{i} ) ]$$

wherein Xᵢ is a subset of target domain images of an i-th part, [symbol] is a mathematical expectation function, and Dᵢₙₜᵣₐ is a target domain discriminator.

This implementation requires three iterative intra-domain adaptation. Firstly, in the first iteration, a subset of 125 target domain images Xₜ¹ and a corresponding subset of pseudo labels [symbol] thereof are added to an originally empty training set Xₜ^{clean} and a corresponding label set [symbol] , respectively, then, the training set of 125 images Xₜ^{clean} as well as the corresponding label set [symbol] and a subset of 125 target domain images Xₜ² are undergone adversarial training, the source-target inter-domain semantic segmentation model Fᵢₙₜₑᵣ is used as an initial target intra-domain semantic segmentation model Fᵢₙₜᵣₐ⁽¹⁾, a segmentation model network structure adopts deeplabV3+, a discriminator network structure is of 4 layers of CNNs, a learning rate is 10⁻⁴, an optimization algorithm is adam, after training 100 epochs, the training is stopped, and Fᵢₙₜᵣₐ⁽²⁾ is obtained after the training is completed; the subset of 125 target domain images Xₜ² is input into the target intra-domain semantic segmentation model Fᵢₙₜᵣₐ⁽²⁾ to obtain a category segmentation probability Pₜ², a subset of pseudo labels [symbol] of the subset of target domain images Xₜ² is obtained according to the segmentation probability Pₜ², the subset of target domain images Xₜ² and the corresponding subset of pseudo labels [symbol] are added to the training set Xₜ^{clean} and the corresponding label set [symbol] , respectively, then, the training set of 250 images Xₜ^{clean} as well as the corresponding label set [symbol] and a subset of 125 target domain images Xₜ³ as well as the intra-domain semantic segmentation model Fᵢₙₜᵣₐ⁽²⁾ are undergone adversarial training, a segmentation model network structure adopts deeplabV3+, a discriminator network structure is of 4layers of CNNs, a learning rate is 10⁻⁴, an optimization algorithm is adam, after training 100 epochs, the training is stopped, and Fᵢₙₜᵣₐ⁽³⁾ is obtained after the training is completed; a subset of 125 target domain images Xₜ³ is input into the target intra-domain semantic segmentation model Fᵢₙₜᵣₐ⁽³⁾ to obtain a category segmentation probability Pₜ³, a subset of pseudo labels [symbol] of the subset of target domain images Xₜ³ is obtained according to the segmentation probability Pₜ³, the subset of target domain images Xₜ³ and the corresponding subset of pseudo labels [symbol] are added to the training set Xₜ^{clean} and the corresponding label set [symbol] , respectively, then, the training set of 375 images Xₜ^{clean} as well as the corresponding label set [symbol] and a subset of 125 target domain images Xₜ⁴ as well as the intra-domain semantic segmentation model Fᵢₙₜᵣₐ⁽³⁾ are undergone adversarial training, a segmentation model network structure adopts deeplabV3+, a discriminator network structure is of 4 layers of CNNs, a learning rate is 10⁻⁴, an optimization algorithm is adam, after training 100 epochs, the training is stopped, and after the training is completed, a final target intra-domain semantic segmentation model Fᵢₙₜᵣₐ (Fᵢₙₜᵣₐ⁽⁴⁾) is obtained.

(5) Inputting the target domain image xₜ into the target intra-domain semantic segmentation model Fᵢₙₜᵣₐ to obtain a final segmentation result map of the target domain image xₜ.

Table 1 shows indexes of precision, recall, F1, and IoU calculated from results obtained from pre-migration, histogram matching (traditional method), a GAN-based inter-domain domain adaptation method, single intra-domain adaptation as well as the iterative intra-domain adaptation strategy of the present invention and label truth values, which are tested by means of relevant experiments.

TABLE 1

| | | | Inter-domain | | Iterative |
|---|---|---|---|---|---|
| | | Histogram | domain | intra-domain | intra-domain |
| | Pre-migration | matching | adaptation | adaptation | adaptation |
| precision | 0.8387 | 0.4184 | 0.8920 | 0.8899 | 0.8884 |
| recall | 0.1548 | 0.2847 | 0.3704 | 0.4033 | 0.4226 |
| F1 | 0.2614 | 0.3389 | 0.5234 | 0.5551 | 0.5728 |
| IoU | 0.1503 | 0.2040 | 0.3545 | 0.3841 | 0.4013 |

From the above experimental results, it can be seen that compared with pre-migration, this implementation effectively improves the IoU index of semantic segmentation, with an improvement of 0.2510. Meanwhile, compared with simple histogram matching, the IoU index of this implementation has also been improved by 0.1973; compared with single intra-domain adaptation and inter-domain domain adaptation, the IoU index of single intra-domain adaptation is improved by 0.0296, indicating that intra-domain adaptation can reduce intra-domain differences. At the same time, compared with single intra-domain adaptation, the IoU index of iterative intra-domain adaptation is further improved by 0.0172, indicating that iterative intra-domain adaptation can further reduce intra-domain differences. Therefore, the present invention is of great help in improving the performance of cross-satellite remote sensing image semantic segmentation.

The above description of the embodiments is for the convenience of those of ordinary skill in the art to understand and apply the present invention. Those familiar with the art can obviously easily make various modifications to the above embodiments and apply the general principles explained here to other embodiments without creative labor. Therefore, the present invention is not limited to the aforementioned embodiments, and the improvements and modifications made by those skilled in the art based on the disclosure of the present invention shall be within the scope of protection of the present invention.

What is claimed is:

1. A cross-domain remote sensing image semantic segmentation method based on iterative intra-domain adaptation and self-training, comprising the following steps:
(1) using a source domain image xₛ, a source domain label yₛ, a source domain semantic segmentation model F_{S}, and a target domain image xₜ to train a source-target inter-domain semantic segmentation model Fᵢₙₜₑᵣ;
(2) inputting the target domain image xₜ into the source-target inter-domain semantic segmentation model Fᵢₙₜₑᵣ to obtain a category segmentation probability Pₜ of the target domain image xₜ, and then using the category segmentation probability Pₜ to calculate segmentation probability credibility Sₜ and a target domain pseudo label [symbol] ;
(3) arranging all target domain images xₜ in descending order according to the segmentation probability credibility Sₜ, and then dividing all the target domain images xₜ into K subsets of target domain images {Xₜ¹, Xₜ², . . . Xₜ^{K}} on average according to an order of arrangement, wherein K is a natural number greater than 1;
(4) using a subset of target domain images Xₜ¹ with highest segmentation probability credibility and a corresponding subset of pseudo labels [symbol] thereof, as well as the source-target inter-domain semantic segmentation model Fᵢₙₜₑᵣ and subsets of target domain images {Xₜ², Xₜ³, . . . Xₜ^{K}} to iteratively train a target intra-domain semantic segmentation model Fᵢₙₜᵣₐ; and
(5) inputting the target domain image xₜ into the target intra-domain semantic segmentation model Fᵢₙₜᵣₐ to obtain a final category segmentation probability P and a segmentation result map of the target domain image xₜ.

2. The cross-domain remote sensing image semantic segmentation method according to claim 1, wherein a specific implementation process of step (1) comprises:
1.1 using the source domain image xₛ and the source domain label yₛ to train the source domain semantic segmentation model F_{S};
1.2 using the source domain image xₛ and the target domain image xₜ to train a source-target domain image bidirectional translation network, comprising a source→target direction image translation network and a target→source direction image translation network;
1.3 for intermediate save models of all image translation networks generated during the training process described above, selecting therefrom a set of optimal results as a source→target direction image translation network G_{S→T} and a target→source direction image translation network G_{T→S};
1.4 using the image translation network G_{S→T} to convert the source domain image xₛ from a source domain to a target domain to obtain a pseudo target domain image G_{S→T}(Xₛ); and
1.5 using the pseudo target domain image G_{S→T}(xₛ) and the source domain label yₛ to train the source-target inter-domain semantic segmentation model Fᵢₙₜₑᵣ.

3. The cross-domain remote sensing image semantic segmentation method according to claim 1, wherein a calculation expression for the segmentation probability credibility Sₜ in step (2) is as follows:
$${S}_{t} = \frac{H \times W \times C}{{\sum }_{h , w} θ ( {P}_{t}^{( h , w , {c}_{1} )} , {P}_{t}^{( h , w , {c}_{2} )} , … , {P}_{t}^{( h , w , {c}_{C} )} )}$$
wherein H and W are a length and a width of the target domain image xₜ, respectively, C is a number of segmentation categories in the target domain image xₜ, Pₜ^{(h,w,c}^{ᵢ}⁾ represents a segmentation probability of a corresponding category cᵢ of a pixel point with coordinates (h, w) in the target domain image xₜ, cᵢ represents an i-th category, i is a natural number and satisfies 1<i>C, and θ( ) is a function used for measuring likelihood between segmentation probabilities of categories of pixel points.

4. The cross-domain remote sensing image semantic segmentation method according to claim 1, wherein a calculation expression for the target domain pseudo label [symbol] in step (2) is as follows:
$${\hat{{y}_{t}}}^{( h , w )} = \{ \begin{matrix}c , if {P}_{t}^{( h , w , c )} > {μ}^{c} or {I}_{t}^{( h , w )} < ν \\ 0 , otherwise\end{matrix}$$
wherein [symbol] ^{(h,w)} represents a category of a pixel point with coordinates (h, w) in the target domain pseudo label [symbol] , Pₜ^{(h,w,c)} represents a segmentation probability of a corresponding category c of the pixel point with coordinates (h, w) in the target domain image xₜ, μ^{c} is a segmentation probability threshold corresponding to the category c,
$$c = arg {max}_{{c}_{i}} {P}_{t}^{( h , w , {c}_{i} )} ,$$
Pₜ^{(h,w,c}^{ᵢ}⁾ represents a segmentation probability of a corresponding category cᵢ of the pixel point with coordinates (h, w) in the target domain image xₜ, cᵢ represents an i-th category, i is a natural number and satisfies 1≤i≤C, C is a number of segmentation categories in the target domain image xₜ, Iₜ^{(h,w)} represents a segmentation probability perplexity of the pixel point with coordinates (h, w) in the target domain image xₜ, and v represents a segmentation probability perplexity threshold.

5. The cross-domain remote sensing image semantic segmentation method according to claim 4, wherein a calculation expression for the segmentation probability perplexity Iₜ^{(h,w)} is as follows:
$${I}_{t}^{( h , w )} = δ ( {P}_{t}^{( h , w , {c}_{1} )} , {P}_{t}^{( h , w , {c}_{2} )} , … , {P}_{t}^{( h , w , {c}_{C} )} )$$
wherein δ( ) is a function used for measuring a perplexity between segmentation probabilities of categories of pixel points.

6. The cross-domain remote sensing image semantic segmentation method according to claim 1, wherein a specific implementation process of step (4) comprises:
4.1 initially using the subset of target domain images Xₜ¹ with highest segmentation probability credibility and the corresponding subset of pseudo labels [symbol] thereof as a training set Xₜ^{clean} and a corresponding label set [symbol] thereof, and using the source-target inter-domain semantic segmentation model Fᵢₙₜₑᵣ as a target intra-domain semantic segmentation model Fᵢₙₜᵣₐ¹; 4.2using the training set Xₜ^{clean}, the label set [symbol] , a target intra-domain semantic segmentation model Fᵢₙₜᵣₐ^{k-1} intra and a subset of target domain images Xₜ^{k} to train a target intra-domain semantic segmentation model Fᵢₙₜᵣₐ^{k}, wherein k is a natural number and satisfies 2≤k≤K;
4.3 inputting the subset of target domain images Xₜ^{k} into the target intra-domain semantic segmentation model Fᵢₙₜᵣₐ^{k} to obtain a corresponding category segmentation probability Pₜ^{k}, and then using the category segmentation probability Pₜ^{k} to calculate a subset of pseudo labels [symbol] of the subset of target domain images Xₜ^{k};
4.4 adding the subset of target domain images Xₜ^{k} and the subset of pseudo labels [symbol] thereof to the training set Xₜ^{clean} and the label set [symbol] , respectively;
4.5 letting k=k+1; and
4.6 repeating steps 4.2 to 4.5 until k=K, and training to obtain a target intra-domain semantic segmentation model Fᵢₙₜᵣₐ^{K}, which is used as the target intra-domain semantic segmentation model Fᵢₙₜᵣₐ.

7. The cross-domain remote sensing image semantic segmentation method according to claim 1, wherein the method is a complete cross-domain remote sensing image semantic segmentation framework, comprising training of source-target inter-domain domain adaptation models, generation of target domain category segmentation probabilities and pseudo labels, sorting of target domain image segmentation probability credibility scores, training of target intra-domain iterative domain adaptation models, and generation of target domain segmentation results.
